(19) United States
(12) Patent Application Publication
(10) Pub. No.: US 2026/0028065 A1
(43) Pub. Date: Jan. 29, 2026

(54) TAILGATE HINGE GUSSET

(71) Applicant: Ford Global Technologies, LLC, Dearborn, MI (US)

(72) Inventors: Jack Marchlewski, Smithville, MO (US); Vincent Anthony Chimento, Plymouth, MI (US); John Comiez, Novi, MI (US)

(21) Appl. No.: 18/785,685

(22) Filed: Jul. 26, 2024

(51) Int. Cl. B62D 33/027; B62D 33/03

(52) U.S. Cl. CPC B62D 33/0273; B62D 33/03

(57) ABSTRACT

An assembly includes a cross member, a pillar positioned adjacent one end of the cross member, and a reinforcement plate that is associated with the cross member. The reinforcement plate includes an extension portion. The assembly further includes a pillar bracket associated with the pillar, a gusset associated with the pillar bracket, and a hinge bracket attached to the pillar bracket.

### TECHNICAL FIELD

This disclosure relates generally to a hinge connection between a tailgate and a vehicle body structure, and relates more specifically to a hinge connection with a reinforcement and gusset to strengthen the connection.

### BACKGROUND

In vehicles such as pickup trucks for example, a cargo bed is provided to hold different types of cargo having various sizes. A tailgate closes off an open end of the cargo bed. The tailgate includes a connection interface to side walls of the cargo bed that allows the tailgate to be moved between open and closed positions to facilitate access to the cargo.

An assembly according to an exemplary aspect of the present disclosure includes, among other things: a cross member; a pillar positioned adjacent one end of the cross member; a reinforcement plate associated with the cross member, the reinforcement plate including an extension portion; a pillar bracket associated with the pillar; a gusset associated with the pillar bracket; and a hinge bracket attached to the pillar bracket.

In a further non-limiting embodiment of any assembly, the gusset is integrally formed with the pillar bracket.

In a further non-limiting embodiment of any assembly, the gusset and the extension portion overlap each other.

In a further non-limiting embodiment of any assembly, the extension portion extends outwardly of the cross member and the gusset extends outwardly of the pillar bracket and rests on an upper surface of the extension portion.

In a further non-limiting embodiment of any assembly, the extension portion extends outwardly of the cross member in a longitudinal direction along a length of a vehicle, and wherein at least a portion of the reinforcement plate defines planar portion that is parallel to ground, and wherein the extension portion is angled downwardly relative to the planar portion in at least one of: a lateral direction across a width of a vehicle, the longitudinal direction.

In a further non-limiting embodiment of any assembly, the extension portion is angled downwardly in the lateral direction and the longitudinal direction.

In a further non-limiting embodiment of any assembly, the cross member comprises a box rear sill, and the pillar comprises a rearmost pillar of a vehicle.

In a further non-limiting embodiment of any assembly, the hinge bracket comprises a pivot connection to a tailgate.

In a further non-limiting embodiment of any assembly, the hinge bracket is on one side of the pillar bracket, and including a dual action strut positioned on an opposite side of the pillar bracket, wherein the dual action strut includes a connection interface associated with the pivot connection to the tailgate.

An assembly according to an exemplary aspect of the present disclosure includes, among other things: a box rear sill extending in a lateral direction across a width of a vehicle; a pillar positioned adjacent one end of the box rear sill; a reinforcement plate associated with the box rear sill, the reinforcement plate including an extension portion outwardly of the box rear sill; a pillar bracket associated with the pillar; a gusset attached to the pillar bracket and positioned adjacent to the extension portion; and a hinge bracket attached to the pillar bracket.

In a further non-limiting embodiment of any assembly, the hinge bracket comprises a pivot connection to a tailgate.

In a further non-limiting embodiment of any assembly, the pillar comprises a rearmost pillar of the vehicle.

In a further non-limiting embodiment of any assembly, the gusset and the extension portion overlap each other.

In a further non-limiting embodiment of any assembly, the gusset is integrally formed with the pillar bracket, and wherein the extension portion is integrally formed with the reinforcement plate.

In a further non-limiting embodiment of any assembly, the gusset extends outwardly of the pillar bracket in a longitudinal direction along a length of the vehicle and rests on an upper surface of the extension portion.

In a further non-limiting embodiment of any assembly, the extension portion extends outwardly of the box rear sill in the lateral direction and in a longitudinal direction along a length of the vehicle, and wherein at least a portion of the reinforcement plate defines planar portion that is parallel to ground, and wherein the extension portion is angled downwardly relative to the planar portion in at least one of: the lateral direction, the longitudinal direction.

In a further non-limiting embodiment of any assembly, the extension portion is angled downwardly in the lateral direction and the longitudinal direction.

In a further non-limiting embodiment of any assembly, the hinge bracket is on one side of the pillar bracket, and including a dual action strut positioned on an opposite side of the pillar bracket, wherein the dual action strut includes a connection interface associated with the pivot connection to the tailgate.

A method according to an exemplary aspect of the present disclosure includes, among other things: positioning a pillar with a pillar bracket adjacent one end of a cross member; associating a reinforcement plate with the cross member; extending an extension portion of the reinforcement plate outwardly of the cross member; extending a gusset outwardly of the pillar bracket; and attaching a hinge bracket to the pillar bracket.

In a further non-limiting embodiment of the method, the method further includes overlapping the extension portion and the gusset with each other.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1A is a perspective illustration of a vehicle with a tailgate in a closed position.

FIG. 1B is similar to FIG. 1A but shows the tailgate in the open position.

FIG. 2 is a perspective illustration of a hinge connection for a tailgate with a reinforcement and gusset.

FIG. 3 is a section view of the reinforcement of FIG. 2.

FIG. 4 is a perspective illustration of the reinforcement and gusset at an initial assembly position.

FIG. 5 is a end view of the reinforcement and gusset of FIG. 4.

FIG. 6 is a perspective illustration of the reinforcement and gusset at a final assembly position.

FIG. 7 is a perspective illustration of a hinge connection for a tailgate with a reinforcement, gusset, and dual action strut connection.

### DETAILED DESCRIPTION

Tailgates have become increasingly complex and offer features that may increase their weight, and consequently lateral hinge loads at a cargo bed interface. There is a desire for a hinge connection interface that is able to counteract the lateral forces from the mass of the tailgate. There is also a desire to design a system for an aluminum bed construction because it is one-third the stiffness of steel.

The subject disclosure details a hinge connection between a tailgate and a vehicle body structure, and relates more specifically to a hinge connection with a reinforcement and gusset to strengthen the connection. As such, a cargo bed with a tailgate hinge support gusset system is provided that allows the transfer of lateral tailgate hinge loads to a rear cross member to provide additional reinforcing support for the connection interface.

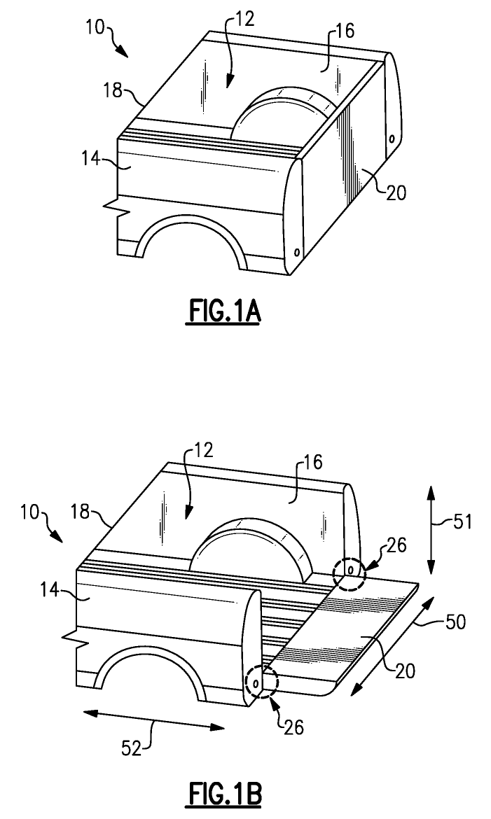

FIG. 1 shows a vehicle 10 with a cargo area 12 defined by a first side wall 14 and a second side wall 16 facing opposite the first side wall 14. A passenger cab (not shown) is at a front of the vehicle and a front bed wall 18 extends along a back of the passenger cab between the first side wall 14 and the second side wall 16 to enclose a front end of the cargo area 12. A tailgate 20 is positioned at a rear of the vehicle 10 and is moveable between an open position and a closed position. FIG. 1A shows the tailgate 20 in the closed position and FIG. 1B shows the tailgate 20 in the open position. When the tailgate 20 is moved to the closed position a rear wall of the cargo area 12 is provided.

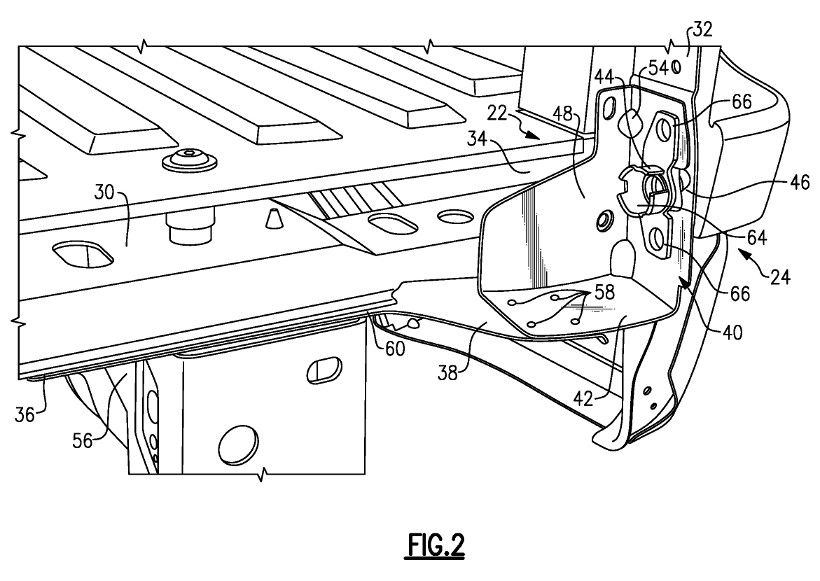

As shown in FIG. 2, a hinge connection 22 is provided between the tailgate 20 and a vehicle structure 24. The location of the hinge connection 22 is schematically identified at 26 in FIG. 1B. The hinge connection 22 allows for the tailgate 20 to pivot between the open and closed position.

As shown in FIG. 2, the vehicle 10 includes a cross member 30, a pillar 32 positioned adjacent one end 34 of the cross member 30, and a reinforcement plate 36 that is associated with the cross member 30. In implementations, the reinforcement plate 36 includes an extension portion 38. In implementations, a pillar bracket 40 is associated with the pillar 32 and a gusset 42 is associated with the pillar bracket 40. A hinge bracket 44 is attached to the pillar bracket 40.

In implementations, the cross member 30 extends in a lateral direction 50 across a width of a vehicle. In one example, the cross member 30 comprises a box rear sill.

In implementations, the pillar 32 comprises a rearmost pillar of the vehicle 10.

In one example, the pillar bracket 40 includes a first portion 46 associated with the pillar 32 and a second portion 48 that is associated with the cross member 30. The first portion 46 comprises a generally flat plate that faces a lateral direction 50 (FIG. 1B) along a width of the vehicle 10, and the second portion 48 comprises a generally flat plate that faces a longitudinal direction 52 along a length of the vehicle 10 to form an L-shaped bracket. In one example, the first portion 46 is welded or otherwise attached to the second portion 48 at an attachment interface 54. In another example, the first 46 and second 48 portions may be integrally formed together as a single-piece bracket.

In implementations, the gusset 42 is integrally formed in one piece with the pillar bracket 40 as shown in FIG. 2. Optionally, the gusset 42 may be separately attached to the pillar bracket 40.

In implementations, the gusset 42 comprises a generally flat plate portion that extends outwardly from a lower edge of the pillar bracket 40 in the longitudinal direction 52. In one example, the gusset 42 extends outwardly from lower edges of both the first portion 46 and the second portion 48.

The hinge connection 22 uses the gusset 42 to allow the transfer of lateral tailgate hinge loads to the rear cross member 30, which is connected to a vehicle frame 56.

In implementations, the gusset 42 can be manufactured as an aluminum or steel stamping, or as an aluminum casting.

In implementations, the gusset 42 and the extension portion 38 overlap each other.

In implementations, the extension portion 38 extends outwardly of the cross member 30 and the gusset 42 extends outwardly of the pillar bracket 40 and rests on an upper surface of the extension portion 38.

In implementations, the gusset 42 and the extension portion 38 are fixed together at an attachment interface 58. In one example, the attachment interface 58 comprises one or more welded joints; however, other attachment methods could also be used.

In implementations, the extension portion 38 extends outwardly of the cross member 30 in the longitudinal direction 52 and in the lateral direction 50. In implementations, the reinforcement plate 36 comprise a generally flat body structure that is positioned below the cross member 30 in a vertical direction 51 (FIG. 1B) defined along a height of the vehicle 10. In one example, at least a portion of the reinforcement plate 36 defines planar portion 60 that is parallel to ground, and in implementations, the extension portion 38 is angled downwardly relative to the planar portion 60 in at least one of the lateral direction 50 and the longitudinal direction 52.

In implementations, the extension portion 38 is integrally formed with the reinforcement plate 36. In other implementations, the extension portion 38 is separately attached to the reinforcement plate 36.

FIG. 3 shows a section view of the reinforcement plate 36 taken at the extension portion 38. In implementations, the extension portion 38 comprises a surface 62 that is angled downwardly in the lateral direction 50 and the longitudinal direction 52.

FIG. 3 shows the surface 62 of the extension portion 38 being angled downwardly in the longitudinal direction 52 relative to the planar portion 60.

FIG. 4 shows the surface 62 of the extension portion 38 being angled downwardly in the lateral direction 50 relative to the planar portion 60.

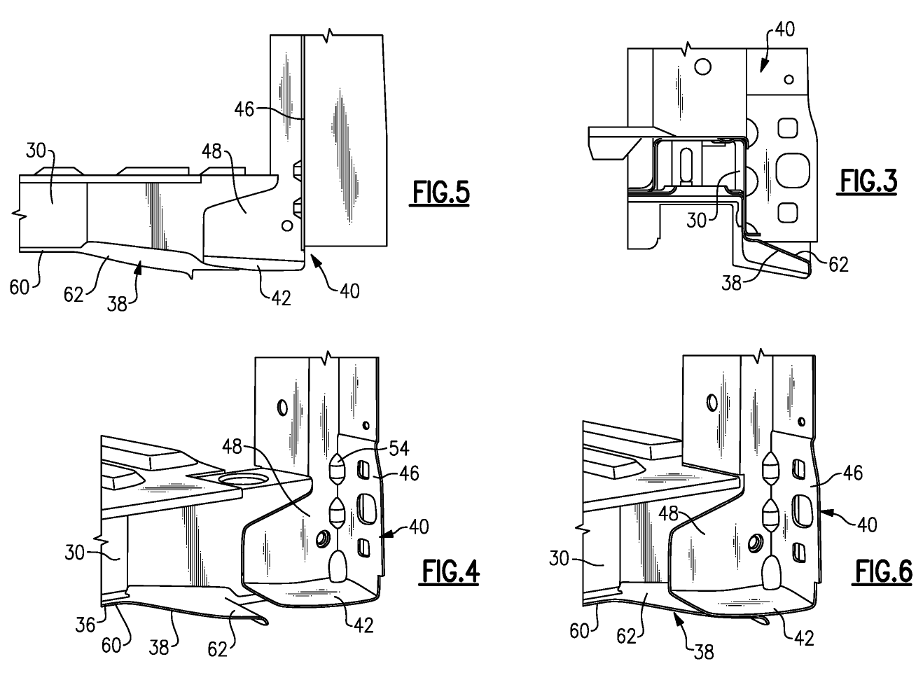

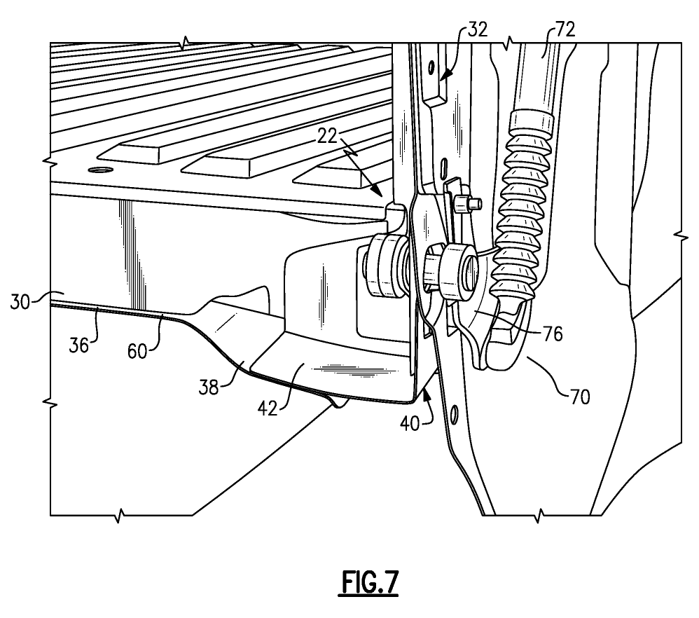

Additionally, FIGS. 4 and 5 show the reinforcement plate 36 and the gusset 42 at an initial assembly position. In this position, the pillar bracket 40 and the gusset 42 as a unit are placed adjacent to each other. From this position, the pillar bracket 40 and gusset 42 can be moved in the lateral direction as a unit to overlap the extension portion 38 as shown in FIG. 6. Once in this final assembly position, the gusset 42 and the extension portion 38 can be fixed together at the attachment interface 58 as shown in FIG. 2.

In implementations, the hinge bracket 44 comprises a pivot connection to the tailgate 20. In one example, the hinge bracket 44 includes a pivot receptacle 64 and one or more mounting flanges 66 that are used to attach the hinge bracket 44 to the pillar bracket 40. In one example, the pivot receptacle 64 is configured to receive a ball joint or other similar structure.

FIG. 7 shows an example of a hinge connection 22 for a tailgate 20 with a reinforcement plate 36, gusset 42, and dual action strut connection 70. As known, a dual action strut 72 can provide both tailgate lift-assist and dampening instead of using torsion rods with separate dampeners. In implementations, dual action struts 72 occupy packaging space that is outboard of the tailgate hinge connection 22, which makes it challenging to reinforce the dual action strut connection 70.

In one example, the connection interface 70 is supported on a fulcrum associated with a strut bracket 76.

The subject disclosure enables the use of dual action struts 72 with heavier tailgates by reinforcing a hinge mounting plane inboard of the hinge connection 22, which allows for strut package and hinge arm motion on the outboard side. In implementations, the hinge bracket 44 is positioned on one side of the pillar bracket 40, and the dual action strut 72 is positioned on an opposite side of the pillar bracket 40. As shown in FIG. 7, the dual action strut 72 includes a connection interface 70 associated with the pivot connection 22 to the tailgate 20.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. An assembly, comprising:
a cross member;
a pillar positioned adjacent one end of the cross member;
a reinforcement plate associated with the cross member, the reinforcement plate including an extension portion;
a pillar bracket associated with the pillar;
a gusset associated with the pillar bracket; and
a hinge bracket attached to the pillar bracket.

2. The assembly of claim 1, wherein the gusset is integrally formed with the pillar bracket.

3. The assembly of claim 1, wherein the gusset and the extension portion overlap each other.

4. The assembly of claim 3, wherein the extension portion extends outwardly of the cross member and the gusset extends outwardly of the pillar bracket and rests on an upper surface of the extension portion.

5. The assembly of claim 1, wherein the extension portion extends outwardly of the cross member in a longitudinal direction along a length of a vehicle, and wherein at least a portion of the reinforcement plate defines planar portion that is parallel to ground, and wherein the extension portion is angled downwardly relative to the planar portion in at least one of:
a lateral direction across a width of a vehicle,
the longitudinal direction.

6. The assembly of claim 5, wherein the extension portion is angled downwardly in the lateral direction and the longitudinal direction.

7. The assembly of claim 1, wherein the cross member comprises a box rear sill, and the pillar comprises a rearmost pillar of a vehicle.

8. The assembly of claim 1, wherein the hinge bracket comprises a pivot connection to a tailgate.

9. The assembly of claim 8, wherein the hinge bracket is on one side of the pillar bracket, and including a dual action strut positioned on an opposite side of the pillar bracket, wherein the dual action strut includes a connection interface associated with the pivot connection to the tailgate.

10. An assembly comprising:
a box rear sill extending in a lateral direction across a width of a vehicle;
a pillar positioned adjacent one end of the box rear sill;
a reinforcement plate associated with the box rear sill, the reinforcement plate including an extension portion outwardly of the box rear sill;
a pillar bracket associated with the pillar;
a gusset attached to the pillar bracket and positioned adjacent to the extension portion; and
a hinge bracket attached to the pillar bracket.

11. The assembly of claim 10, wherein the hinge bracket comprises a pivot connection to a tailgate.

12. The assembly of claim 11, wherein the pillar comprises a rearmost pillar of the vehicle.

13. The assembly of claim 12, wherein the gusset and the extension portion overlap each other.

14. The assembly of claim 13, wherein the gusset is integrally formed with the pillar bracket, and wherein the extension portion is integrally formed with the reinforcement plate.

15. The assembly of claim 13, wherein the gusset extends outwardly of the pillar bracket in a longitudinal direction along a length of the vehicle and rests on an upper surface of the extension portion.

16. The assembly of claim 13, wherein the extension portion extends outwardly of the box rear sill in the lateral direction and in a longitudinal direction along a length of the vehicle, and wherein at least a portion of the reinforcement plate defines planar portion that is parallel to ground, and wherein the extension portion is angled downwardly relative to the planar portion in at least one of:
the lateral direction,
the longitudinal direction.

17. The assembly of claim 16, wherein the extension portion is angled downwardly in the lateral direction and the longitudinal direction.

18. The assembly of claim 11, wherein the hinge bracket is on one side of the pillar bracket, and including a dual action strut positioned on an opposite side of the pillar bracket, wherein the dual action strut includes a connection interface associated with the pivot connection to the tailgate.

19. A method comprising:
positioning a pillar with a pillar bracket adjacent one end of a cross member;
associating a reinforcement plate with the cross member;
extending an extension portion of the reinforcement plate outwardly of the cross member;
extending a gusset outwardly of the pillar bracket; and
attaching a hinge bracket to the pillar bracket.

20. The method of claim 19, including overlapping the extension portion and the gusset with each other.
